(19) United States
(12) Patent Application Publication
(10) Pub. No.: US 2017/0298905 A1
(43) Pub. Date: Oct. 19, 2017

(54) SYSTEM AND METHOD FOR CONTROLLING OUTPUT EVAPORATION RATE OF WIND POWER PLANT

(71) Applicants: Korea Electric Power Corporation, Naju-si, Jeollanam-do (KR); INDUSTRIAL COOPERATION FOUNDATION CHONBUK NATIONAL UNIVERSITY, Jeonju-si, Jeollabuk (KR)

(72) Inventors: Sang Ho PARK, Daejeon (KR); Ki Joo KWON, Daejeon (KR); Gi-Gab YOON, Daejeon (KR); Young Do CHOY, Daejeon (KR); Yong Chul KANG, Jeonju-si, Jeollabuk-do (KR)

(21) Appl. No.: 15/514,330

(22) PCT Filed: May 20, 2015
(86) PCT No.: PCT/KR2015/005068

§ 371 Date: Mar. 24, 2017

(30) Foreign Application Priority Data
Sep. 25, 2014 (KR) 10-2014-0128227

(51) Int. Cl. F03D 7/02; F03D 9/257

(52) U.S. Cl. CPC F03D 7/0284; F03D 9/257

(57) ABSTRACT

The present invention relates to a system and method for controlling an output evaporation rate of a wind power plant. The system includes a wind power plant control unit configured to measure an output value of a wind power plant before a predetermined time from an output control time of the wind power plant, calculate a maximum output value of the wind power plant on the basis of the measured output value of the wind power plant, and distributing individual maximum output values of the wind power plant to individual wind power generators in the wind power plant and a wind power generator control unit configured to control outputs of the individual wind power generators according to the individual maximum output values when the individual maximum output values are distributed to the individual wind power generators.

### TECHNICAL FIELD

The present invention relates a system and method for controlling an output evaporation rate of a wind power plant, and more particularly, to a system and method for controlling an output evaporation rate of a wind power plant, the system and method being capable of enhancing stability of a power system by controlling an output of the wind power plant such that changes in outputs of the wind power plant and a point of common coupling do not threaten the stability of the power system when the output of the wind power plant is changed due to a rapid change in wind speed.

### BACKGROUND ART

Typically, in order to stably operate a power system, a frequency of the power system should be maintained within an allowable range. In order to satisfy this, supply and demand of power in the power system should be balanced.

However, for a power system having a high demand factor of wind power energy, a significant change in wind speed may lead to an excessive change in output of wind power energy, thus adversely affecting frequency stability of the power system. Moreover, a synchronous generator of a conventional power network has an evaporation rate with a finite value. Accordingly, a power system interconnection standard specifies a rule that maintain an output evaporation rate of the wind power plant caused by a change in wind speed at a certain value or less. Accordingly, the rule is followed by setting a maximum output value or an evaporation rate limit value of a wind power generator.

Here, an output evaporation rate refers to a rate of increase in an active power output of a power generator.

In more detail, an output of a wind power generator or wind power plant is controlled in advance by predicting the output of the wind power generator and wind power plant on the basis of weather data of a meteorological agency and then determining an increase in evaporation rate.

However, actually, the weather data of the meteorological agency may have low accuracy when a weather condition changes suddenly, and thus the prediction of the output of the wind power generator may be inaccurate. When the output increases at a higher rate than the rule specified in the power system interconnection standard, synchronous generators in a conventional power network cannot compensate for the rapid increase in the output of the wind power plant, because of the inaccurate output prediction, which results in deterioration of power quality.

For reference, unlike conventional nuclear power generation and thermal power generation, wind power energy is characterized in that output changes with a change in wind pattern. Thus, since wind speed changing suddenly may decrease frequency stability of a power network connected with a wind power plant, a power system operator (TSO) limits a change in output of wind power generation in the range of evaporation rates of conventional power generating sources through a grid code. Furthermore, an output control function of a new renewable energy source is being required through a system interconnection standard for new renewable power generation facilities in this country. For example, it is required that an output evaporation rate of active power can be limited to 10% of a rating per minute.

Accordingly, when an output of a wind power plant changes with a sudden change in wind speed, there is a need for a system and method for controlling an output of the wind power plant to follow the evaporation rate rule of the power system interconnection standard.

The background of the present invention is disclosed in Korean Patent Application Publication No. 10-2010-0064492 (entitled “Power Conditioning Wind Power Generation System Using Energy Storage Device and thereof Control Method” and published on Jun. 15, 2010).

### DETAILED DESCRIPTION OF THE INVENTION

### Technical Problem

The present invention is designed to solve the above problems and is intended to provide a system and method for controlling an output evaporation rate of a wind power plant, the system and method being capable of enhancing stability of a power system by controlling an output of the wind power plant such that changes in outputs of the wind power plant and a point of common coupling do not threaten the stability of the power system when the output of the wind power plant is changed due to a rapid change in wind speed.

### Technical Solution

According to an aspect of the present invention, a system for controlling an output evaporation rate of a wind power plant includes a wind power plant control unit configured to measure an output value of the wind power plant before a predetermined time from an output control time of the wind power plant, calculate a maximum output value of the wind power plant based on the measured output value of the wind power plant, and distribute individual maximum output values of the wind power plant to individual wind power generators in the wind power plant; and a wind power generator control unit configured to control outputs of the individual wind power generators according to the individual maximum output values when the individual maximum output values are distributed to the individual wind power generators.

According to the present invention, the maximum output value of the wind power plant is an output value that a sum of the outputs of the wind power generators in the wind power plant should not exceed.

According to the present invention, the wind power plant control unit calculates the maximum output value of the wind power plant by adding an output value corresponding to an output evaporation rate per minute that is specified in a power network interconnection standard to the measured output value of the wind power plant.

According to the present invention, the wind power plant control unit distributes the individual maximum output values in proportion to maximum available outputs of the individual wind power generators or in proportion to outputs of the individual wind power generators at the output control time of the wind power plant.

According to the present invention, the wind power generator control unit finally prevents an output of the wind power plant from exceeding the maximum output value (Pᵤₚₚₑᵣₗᵢₘᵢₜ^{WPP}) by controlling the outputs of the individual wind power generators such that the outputs do not exceed the distributed individual maximum output values.

According to the present invention, the wind power generator control unit sets original reference output values (P_{ref}^{WGi}) of the individual wind power generators to new reference output values (P_{newrej}^{WGi}) by limiting the original reference output values (P_{ref}^{WGi}) to the individual maximum output values (Pᵤₚₚₑᵣₗᵢₘᵢₜ^{WGi}) that are distributed by the wind power plant control unit, calculates output errors by performing mathematical operations on the new reference output values (P_{newrej}^{WGi}) and output values (Pₘₑₐₛ^{WGi}) that are measured at terminals of the wind power generators, calculates reference current values (I_{d-rej}^{WGi}) of the individual wind power generators by performing mathematical operations on the output errors through a proportional integral controller, calculates current errors by performing mathematical operations on the reference current values (I_{d-rej}^{WGi}) and current values (I_{d}^{WGi}) measured at the individual wind power generators, calculates reference voltage values (V_{d-rej}^{WGi}) of the individual wind power generators by performing mathematical operations on the current errors through the proportional integral controller, and controls the outputs by machine-side converters (MSCs) of the individual wind power generators providing power corresponding to the reference voltage values (V_{d-rej}^{WGi}) of the individual wind power generators calculated through the proportional integral controller to a system.

According to the present invention, when the original reference output values (Pᵣₑⱼ^{WGi}) of the individual wind power generators are greater than the individual maximum output values (Pᵤₚₚₑᵣₗᵢₘᵢₜ^{WGi}), the new reference output values (P_{newrej}^{WGi}) are set equal to the individual maximum output values (Pᵤₚₚₑᵣₗᵢₘᵢₜ^{WGi}), and otherwise, the new reference output values (P_{newrej}^{WGi}) are set equal to the original reference output values (P_{ref}^{WGi}).

According to another aspect of the present invention, a method of controlling an output evaporation rate of a wind power plant includes measuring, by a wind power plant control unit, an output value of the wind power plant before a predetermined time from an output control time of the wind power plant; calculating, by the wind power plant control unit, a maximum output value of the wind power plant based on the measured output value of the wind power plant; distributing, by the wind power plant control unit, individual maximum output values of the wind power plant to individual wind power generators in the wind power plant; and controlling, by a wind power generator control unit, outputs of the individual wind power generators according to the individual maximum output values when the individual maximum output values are distributed to the individual wind power generators.

According to the present invention, when the maximum output value of the wind power plant is calculated, the wind power plant control unit calculates the maximum output value of the wind power plant by adding an output value corresponding to an output evaporation rate per minute that is specified in a power network interconnection standard to the measured output value of the wind power plant.

According to the present invention, when the individual maximum output values of the wind power plant are distributed to the individual wind power generators in the wind power plant, the wind power plant control unit distributes the individual maximum output values in proportion to maximum available outputs of the individual wind power generators or in proportion to outputs of the individual wind power generators at the output control time of the wind power plant.

According to the present invention, when the outputs of the individual wind power generators are controlled, the wind power generator control unit sets original reference output values (P_{ref}^{WGi}) of the individual wind power generators to new reference output values (P_{newrej}^{WGi}) by limiting the original reference output values (P_{ref}^{WGi}) to the individual maximum output values (Pᵤₚₚₑᵣₗᵢₘᵢₜ^{WGi}) that are distributed by the wind power plant control unit, calculates output errors by performing mathematical operations on the new reference output values (P_{newrej}^{WGi}) and output values (Pₘₑₐₙₛ^{WGi}) that are measured at terminals of the wind power generators, calculates reference current values (Pₘₑₐₛ^{WGi}) of the individual wind power generators by performing mathematical operations on the output errors through a proportional integral controller, calculates current errors by performing mathematical operations on the reference current values (I_{d-rej}^{WGi}) and current values (I_{d}^{WGi}) that are measured at the individual wind power generators, calculates reference voltage values (V_{d-rej}^{WGi}) of the individual wind power generators by performing mathematical operations on the current errors through the proportional integral controller, and controls the outputs by machine-side converters (MSCs) of the individual wind power generators providing power corresponding to the reference voltage values (V_{d-rej}^{WGi}) of the individual wind power generators calculated through the proportional integral controller to a system.

According to the present invention, when the original reference output values (P_{ref}^{WGi}) of the individual wind power generators are greater than the individual maximum output values (Pᵤₚₚₑᵣₗᵢₘᵢₜ^{WGi}), the new reference output values (P_{newrej}^{WGi}) are set equal to the individual maximum output values (Pᵤₚₚₑᵣₗᵢₘᵢₜ^{WGi}), and otherwise, the new reference output values (P_{newrej}^{WGi}) are set equal to the original reference output values (P_{ref}^{WGi}).

### ADVANTAGEOUS EFFECTS OF THE INVENTION

According to the present invention, it is possible to enhance stability of a power system by controlling an output of a wind power plant such that changes in outputs of the wind power plant and a point of common coupling do not threaten the stability of the power system when the output of the wind power plant is changed due to a rapid change in wind speed.

### DESCRIPTION OF THE DRAWINGS

FIG. 1 is an example diagram of a schematic configuration of a system for controlling an output evaporation rate of a wind power plant according to an embodiment of the present invention.

FIG. 2 is an example diagram for describing an algorithm in which a wind power plant control unit of FIG. 1 calculates a maximum output value of the wind power plant.

FIG. 3 is an example diagram for describing an algorithm in which a wind power generator control unit of FIG. 1 controls individual wind power generators.

FIG. 4 is a graph showing an output of a wind power plant according to an output evaporation rate control system of the wind power plant according to an embodiment of the present invention.

FIG. 5 is a graph showing an output evaporation rate of a wind power plant according to an output evaporation rate control system of the wind power plant according to an embodiment of the present invention.

FIG. 6 is a graph showing an output of an i^{th} individual wind power generator included in a wind power plant according to an embodiment of the present invention.

FIG. 7 is a graph showing a rotator speed of an i^{th} individual wind power generator included in a wind power plant according to an embodiment of the present invention.

FIG. 8 is a flowchart for describing a method of controlling an output evaporation rate of a wind power generator according to an embodiment of the present invention.

### MODE OF THE INVENTION

Hereinafter, an embodiment of a system and method for controlling an output evaporation rate of a wind power plant according to the present invention will be described with reference to the accompanying drawings.

In the drawings, thicknesses of lines or sizes of elements may be exaggerated for clarity and convenience. Moreover, the following terms are defined considering functions of the present invention, and may be differently defined depending on a user, the intent of an operator, or a custom. Therefore, the terms should be defined based on overall contents of the specification.

A system for controlling an output evaporation rate of a wind power plant according to an embodiment of the present invention may enable a large wind power plant to stably operate its associated power system by controlling an output of the wind power plant on the basis of output data of a point of common coupling so that output variations of the wind power plant and the point of common coupling do not exceed an output evaporation rate per minute that is required by a power system interconnection standard.

As described above, an output of a wind power plant changes depending on wind patterns. In a related art, an output evaporation rate of a wind power plant is controlled by predicting the wind patterns or the amount of output. Accordingly, when the prediction of the weather and the amount of output is inaccurate, it is difficult to maintain the output evaporation rate required by the power system interconnection standard.

However, a system for controlling an output evaporation rate of a wind power plant according to an embodiment of the present invention may calculate a “maximum output value” of the wind power plant by adding an “output value corresponding to the output evaporation rate per minute” specified in the power network interconnection standard to an “output value before 1 minute” measured at a point of common coupling of the wind power plant in order to suppress an output evaporation rate of the point of common coupling of the wind power plant and may follow the rule for the evaporation rate per minute of the power network interconnection standard by using the method of suppressing the output of the wind power plant at a current time on the basis of the “maximum output value.”

Accordingly, there is no need to predict the wind patterns or the output of the wind power plant.

As described above, the present invention suppresses a current output of the wind power plant on the basis of an output value measured at the point of common coupling before a predetermined time (e.g., 1 minute) and thus can accurately suppress an output evaporation rate of the point of common coupling, compared to the conventional method that uses information obtained through inaccurate prediction.

In other words, the system for controlling an output evaporation rate of a wind power plant according to an embodiment of the present invention includes a wind power plant control unit configured to measure an output value of the wind power plant before a predetermined time (e.g., 1 minute) from a control time, calculate a maximum output value of the wind power plant from the measured output value of the wind power plant, and distribute individual maximum output values of the wind power plant to individual wind power generators, and a wind power generator control unit configured to control the individual wind power generators according to the distributed individual maximum output values.

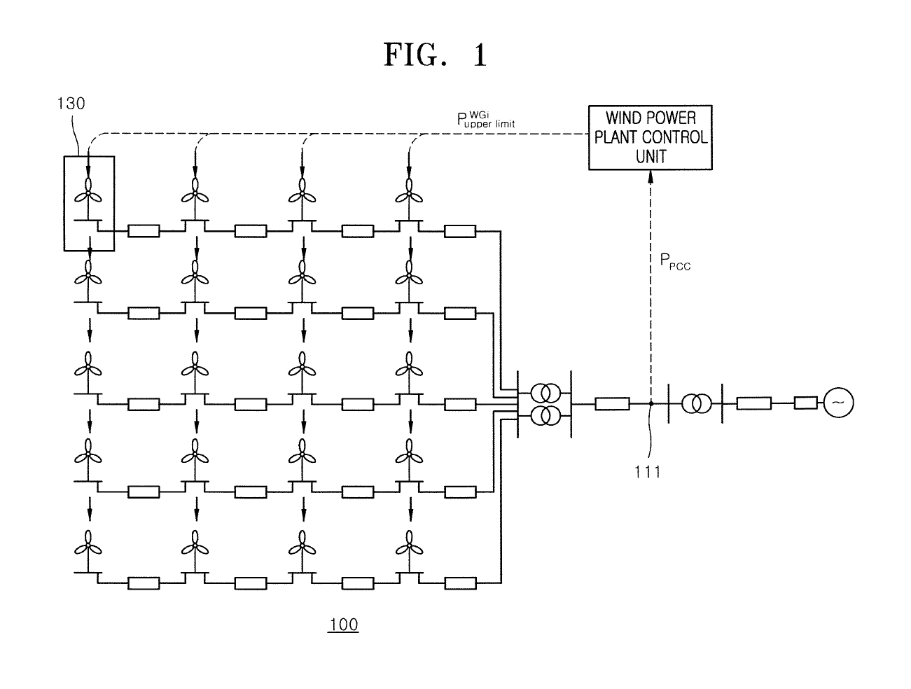

Hereinafter, a system and method for controlling an output evaporation rate of a wind power plant according to an embodiment of the present invention will be described with reference to FIGS. 1 to 8.

FIG. 1 is an example diagram of a schematic configuration of a system for controlling an output evaporation rate of a wind power plant according to an embodiment of the present invention.

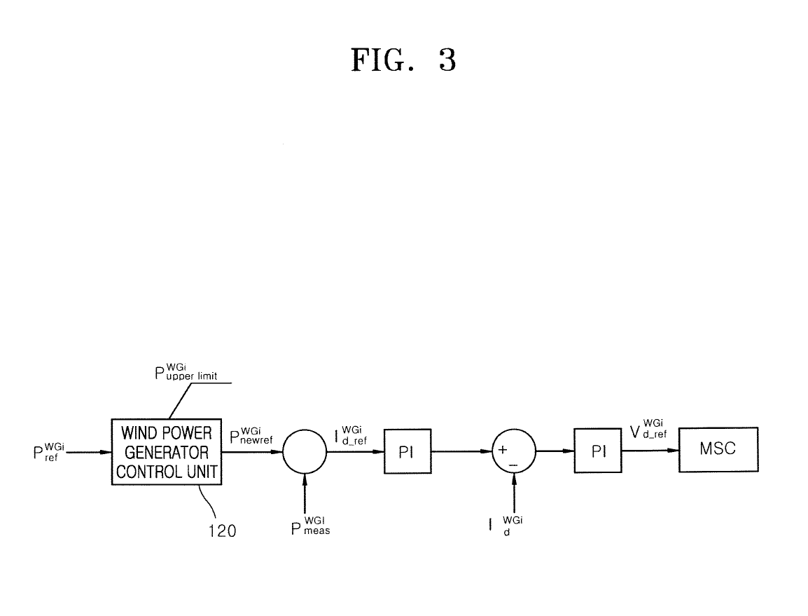

As shown in FIG. 1, an output evaporation rate control system 100 for a wind power plant according to this embodiment includes a wind power plant control unit 110, a wind power generator control unit 120 (see FIG. 3), and at least one or more individual wind power generators 130.

The wind power plant control unit 110 calculates a maximum output value of the wind power plant.

In more detail, the wind power plant control unit 110 measures an output of the wind power plant at a predetermined time and calculates a maximum output value of the wind power plant on the basis of the measured output.

The maximum output value of the wind power plant is an output value that a total of wind power generators should not exceed. For example, the maximum output value is a value obtained by considering an output value before 1 minute of the wind power plant at the point of common coupling and also an evaporation rate reference specified in a power network interconnection standard. At present, 10% of an installation capacity of the wind power plant is specified as an evaporation rate per minute. However, when the power network interconnection standard is changed later, the evaporation rate per minute may be variously adjusted.

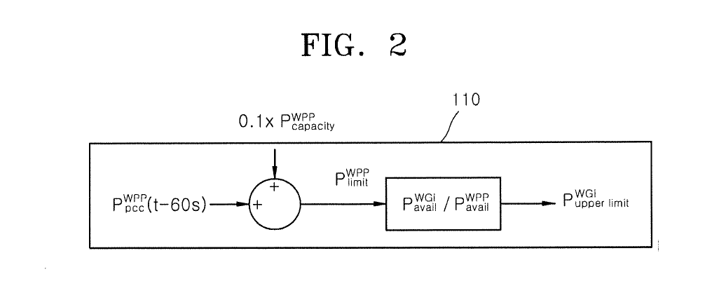

A method in which the wind power plant control unit 110 calculates the maximum output value will be described below with reference to FIG. 2.

FIG. 2 is an example diagram for describing an algorithm in which the wind power plant control unit of FIG. 1 calculates the maximum output value of the wind power plant.

The wind power plant control unit 110 measures an output of the wind power plant before a predetermined time (e.g., 1 minute) from a control time in order to calculate the maximum output value. For example, preferably, the wind power plant control unit 110 measures an output at a point of common coupling 111.

The wind power plant control unit 110 may calculate the maximum output value on the basis of the output before the predetermined time (e.g., 1 minute) from the control time as described above, compare the calculated maximum output value with an output predicted based on conventional weather data of a meteorological agency, and accurately adjust the output of the wind power plant to satisfy a rule for the evaporation rate per minute of the power network interconnection standard. That is, since the weather data of the meteorological agency is predicted data, the data may have low accuracy when a weather condition changes suddenly. However, since the wind power plant control unit 110 calculates the maximum output value on the basis of the output before the predetermined time from the control time, the wind power plant control unit 110 may calculate a result with high accuracy to which a weather condition near the control time is reflected.

Here, the predetermined time may be variously set. However, it is preferable to increase reliability of the calculated output by setting the predetermined as 60 seconds and reflecting the weather condition near the control time.

Subsequently, the wind power plant control unit 110 calculates the maximum output value of the wind power plant by adding an output value corresponding to the output evaporation rate per minute that is specified in the power network interconnection standard to the measured output value of the wind power plant.

Considering, for example, the evaporation rate as 10% of the installation capacity of the wind power plant, which is currently specified in the power network interconnection standard, the maximum output value may be expressed as the following Equation 1:

$${P}_{upperlimit}^{WPP} = {P}_{PCC}^{WPP} ( t - 60 s ) + 0.1 \times {P}_{capacity}^{WPP} \qquad [ Equation 1 ]$$

where Pᵤₚₚₑᵣₗᵢₘᵢₜ^{WPP} is the calculated maximum output value of the wind power plant, P_{PCC}^{WPP} is the output value of the wind power plant that is measured at the point of common coupling (PCC), and P_{capacity}^{WPP} is the installation capacity of the wind power plant, and t is the control time.

As described above, the measured output value is a value that is measured at a time point before a predetermined time (e.g., 60 seconds) from the control time. Accordingly, a weather condition near the control time may be reflected, and 10% of a rated capacity of the wind power plant, which is the output evaporation rate standard specified in the power network interconnection standard, is considered as the evaporation rate.

When the maximum output value of the wind power plant is calculated as described above, individual maximum output values are distributed to the individual wind power generators 130. In more detail, the wind power plant control unit 110 distributes the individual maximum output values Pᵤₚₚₑᵣₗᵢₘᵢₜ^{WGi} in proportion to maximum available outputs of the individual wind power generators 130 (Pᵤₚₚₑᵣₗᵢₘᵢₜ^{WPP}×Pₐᵥₐᵢₗ^{WGi}/Pₐᵥₐᵢₗ^{WPP}).

In this case, as the wind power plant control unit 110 distributes the individual maximum output values in proportion to the maximum available outputs of the individual wind power generators 130, a higher maximum output value is distributed to a wind power generator having a high maximum available output than to a wind power generator having a low maximum available output. Accordingly, when the output of the wind power plant is decreased, the probability of an additional trouble occurring due to excessive rotor acceleration significantly decreases.

The distribution of the maximum output values is not limited to the method of distributing the maximum output values in proportion to the maximum available outputs of the individual wind power generators 130 and may utilize various methods such as distribution in proportion to outputs of the individual wind power generators 130 at the control time.

The wind power generator control unit 120 (see FIG. 3) is formed inside or outside the individual wind power generators 130 and controls the individual wind power generators 130 according to the individual maximum output values Pᵤₚₚₑᵣₗᵢₘᵢₜ^{WGi} that are distributed by the wind power plant control unit 110.

The maximum output value Pᵤₚₚₑᵣₗᵢₘᵢₜ^{WPP} of the wind power plant is calculated by summing the maximum output values Pᵤₚₚₑᵣₗᵢₘᵢₜ^{WGi} of the individual wind power generators 130 that are distributed by the wind power plant control unit 110, and the individual wind power generators 130 is controlled not to exceed the maximum output values Pᵤₚₚₑᵣₗᵢₘᵢₜ^{WGi} that are distributed by the wind power generator control unit 120. As a result, an output of the wind power plant does not exceed the maximum output value Pᵤₚₚₑᵣₗᵢₘᵢₜ^{WPP} of the wind power plant.

FIG. 3 is an example diagram for describing an algorithm in which the wind power generator control unit of FIG. 1 controls individual wind power generators.

Referring to FIG. 3, the wind power generator control unit 120 sets original reference output values P_{ref}^{WGi} of the individual wind power generators 130 to new reference output values P_{newrej}^{WGi} by limiting the original reference output values P_{ref} ^{WGi} to the individual maximum output values Pᵤₚₚₑᵣₗᵢₘᵢₜ^{WGi} that are distributed by the wind power plant control unit 110. In this case, when the original reference output values P_{ref}^{WGi} of the individual wind power generators 130 are greater than the individual maximum output values Pᵤₚₚₑᵣₗᵢₘᵢₜ^{WGi}, the new reference output values P_{newrej}^{WGi} are set equal to the individual maximum output values Pᵤₚₚₑᵣₗᵢₘᵢₜ^{WGi}. Otherwise, the new reference output values P_{newrej}^{WGi} are set equal to the original reference output values P_{ref}^{WGi}.

Subsequently, the wind power generator control unit 120 calculates output errors by performing mathematical operations on the new reference output values P_{newrej}^{WGi} and output values Pₘₑₐₙₛ^{WGi} that are measured at terminals of the wind power generators and then calculates reference current values I_{d-rej}^{WGi} of the individual wind power generators 130 by performing mathematical operations on the output errors through a proportional integral controller PI.

The wind power generator control unit 120 calculates current errors by performing mathematical operations on the reference current values I_{d-rej}^{WGi} and current values I_{d}^{WGi} that are measured at the individual wind power generators 130, and then calculates reference voltage values V_{d-rej}^{WGi} of the individual wind power generators by performing mathematical operations on the current errors through the proportional integral controller PI.

Finally, the wind power generator control unit 120 controls the outputs by machine-side converters (MSCs) of the individual wind power generators 130 providing power corresponding to the reference voltage values V_{d-rej}^{WGi} of the individual wind power generators 130 calculated through the proportional integral controller PI to the system.

Since the wind power generator control unit 120 controls the outputs of the individual wind power generators 130 according to the above algorithm, the total output of the wind power plant may be prevented from exceeding the maximum output value Pᵤₚₚₑᵣₗᵢₘᵢₜ^{WPP}.

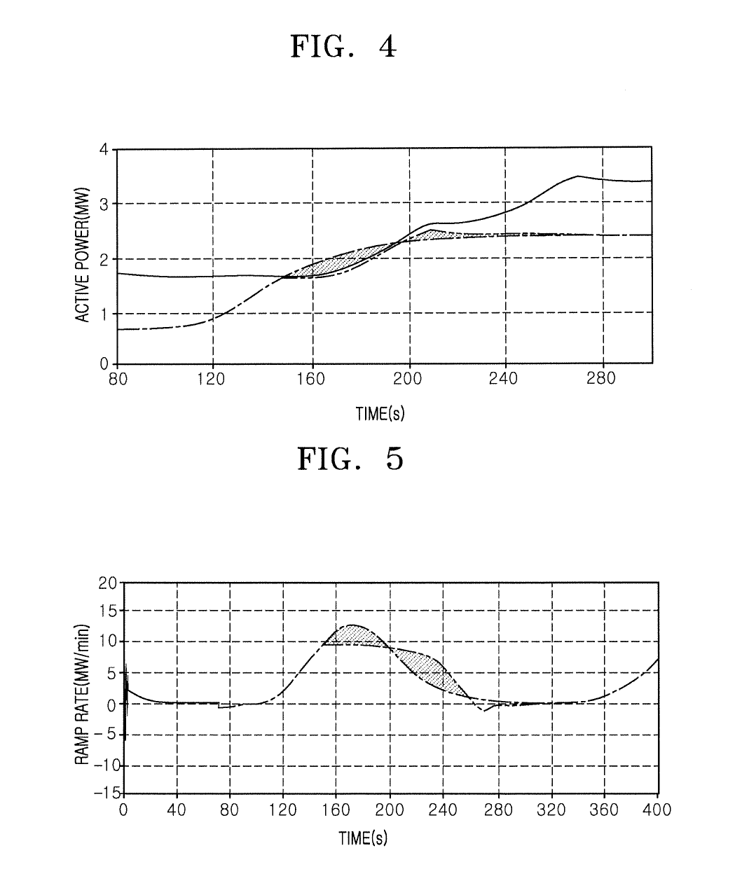

FIG. 4 is a graph showing an output of a wind power plant according to an output evaporation rate control system of the wind power plant according to an embodiment of the present invention, and FIG. 5 is a graph showing an output evaporation rate of a wind power plant according to an output evaporation rate control system of a wind power plant according to an embodiment of the present invention.

In the above graphs, a solid line denotes the maximum output value of the wind power plant, a dashed-dot line denotes an output of the wind power plant to which the output evaporation rate control system 100 of the wind power plant is not applied, and a dashed-double-dot line denotes an output of the wind power plant to which the output evaporation rate control system 100 of the wind power plant is applied (FIG. 5 shows an output evaporation rate of the wind power plant).

Referring to the graph of FIG. 4, it can be seen that the output of the wind power plant to which the output evaporation rate control system 100 of the wind power plant according to this embodiment is not applied (see the dashed-dot line graph) exceeds the solid line indicating the maximum output value of the wind power plant in the range of about 150 seconds to about 190 seconds. This can also be seen in the corresponding range (from 150 seconds to 190 seconds) of FIG. 5, which is a graph for the output evaporation rate because the output evaporation rate of the wind power plant is increased due to a significant increase in wind speed.

On the other hand, it can be seen that the output to which the output evaporation rate control system 100 of the wind power plant according to this embodiment is applied (see the dashed-double-dot line graph) in the corresponding range (from 150 seconds to 190 seconds) is controlled below the solid line indicating the maximum output value. This is because the output evaporation rate control system 100 of the wind power plant according to this embodiment controls an output evaporation rate of the wind power plant in the corresponding range.

Referring to the graph of FIG. 5, it can be seen that the output to which the output evaporation rate control system 100 of the wind power plant according to this embodiment is applied (see the dashed-double-dot line graph) in the corresponding range (from 150 seconds to 190 seconds) is maintained at a constant level below the output evaporation rate reference graph.

The output controlled in the corresponding range may be stored in a rotor (not shown) and used after about 190 seconds at which the control is finished. That is, energy corresponding to an area (the left shaded area) where the output to which the output evaporation rate control system 100 according to this embodiment is not applied (see the dashed-double-dot line graph) exceeds the solid line indicating the maximum output value in the range of about 150 seconds to about 190 seconds, except for energy flowing out by operating a pitch controller (not shown), may be stored in a rotator and may be output and used after the control is finished (the right shaded area).

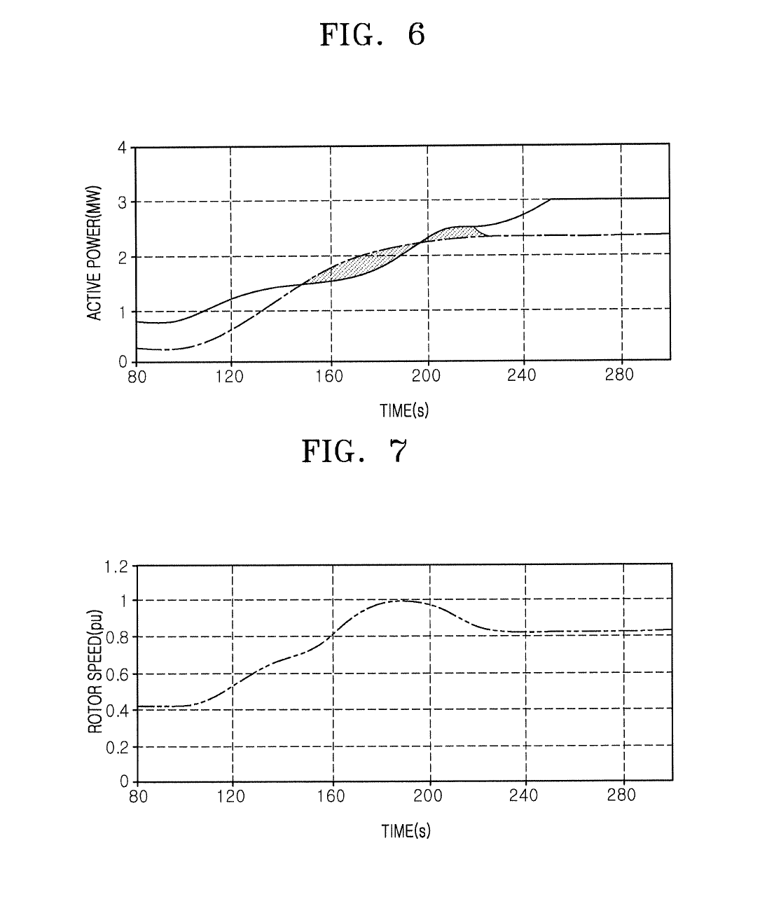

FIG. 6 is a graph showing an output of an individual wind power generator included in a wind power plant according to an embodiment of the present invention.

Likewise, a solid line denotes a maximum output value of an individual wind power generator, a dashed-dot line denotes an output of the individual wind power generator 130 to which the output evaporation rate control system 100 of the wind power plant according to this embodiment is not applied, and a dashed-double-dot line denotes an output of the individual wind power generator 130 to which the output evaporation rate control system 100 of the wind power plant according to this embodiment is applied.

The output of the individual wind power generator 130 can be seen by referring to FIG. 6.

An individual maximum output value distributed by the wind power plant control unit 110 is set for the individual wind power generator 130, and an output of the wind power generator is controlled by the wind power generator control unit 120 in the range in which the output exceeds the maximum output value.

Here, it has been described that the individual maximum output value may be different for each individual wind power generator 130 because the individual maximum output value is distributed in proportion to the maximum available output of the individual wind power generator 130.

Like the wind power plant, the control of the individual wind power generator 130 begins at about 150 seconds at which the output exceeds the maximum output value and ends at about 190 seconds at which the output falls below the maximum output value. Moreover, it should be appreciated that energy corresponding to an area where the output exceeds the maximum output value, except for energy flowing out by operating a pitch controller (not shown), may be stored in a rotator (not shown) and may be output and used after the control is finished.

An algorithm in which the output is stored in a rotator (not shown) from a time at which the control is started because the output exceeds the maximum output value to a time at which the control is finished because the output falls below the maximum output value will be described below.

For example, when the output of the individual wind power generator 130 exceeds the predetermined maximum output value of the individual wind power generator 130, the control of the output is started by the wind power generator control unit 120. In this case, an output value Pₘₑₐₛ^{WGi} that is measured at a terminal of the wind power generator decreases, and thus a rotator speed of the wind power generator increases. Accordingly, kinetic energy in a rotator (not shown) also increases and then is stored. Subsequently, when the output of the individual wind power generator 130 falls below the maximum output value, the wind power generator control unit 120 ends the control of the output of the individual wind power generator 130. Thus, the output value Pₘₑₐₛ^{WGi} that is measured at the terminal of the wind power generator increases again, and thus the speed of the rotator (not shown) decreases. Accordingly, the kinetic energy stored in the rotator (not shown) is emitted as the output of the individual wind power generator 130.

FIG. 7 is a graph showing a rotator speed of an i^{th} individual wind power generator included in a wind power plant according to an embodiment of the present invention.

Referring to the graph of FIG. 7, it can be seen that the speed of the rotator (not shown) increases rapidly at about 150 seconds at which the control of the output is started by the wind power generator control unit 120 and decreases at about 190 seconds at which the control is finished. That is, the speed of the rotator (not shown) is stored as kinetic energy from about 150 seconds at which the control of the output is started and thus the speed of the rotator (not shown) increases to about 190 seconds at which the control of the output is finished and thus the speed of the rotator (not shown) decreases.

The sum total of kinetic energy stored in rotators (not shown) of i individual wind power generators 130 constituting the wind power plant during the control period is the same within a certain error range as the entire kinetic energy stored in the wind power plant during the control period.

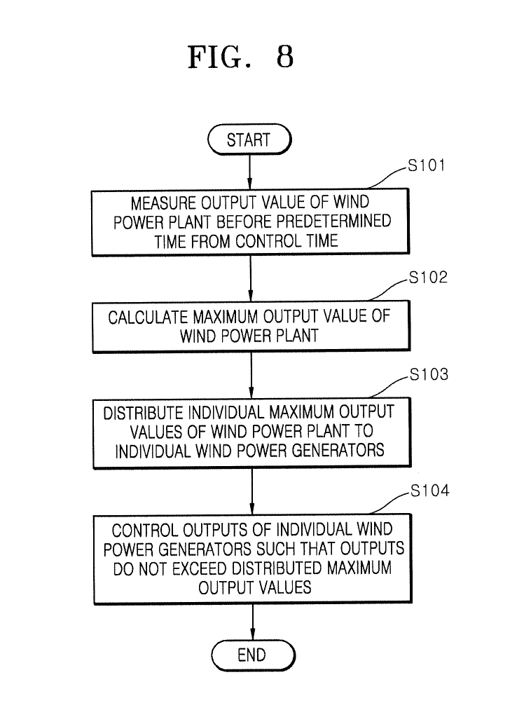

FIG. 8 is a flowchart for describing a method of controlling an output evaporation rate of a wind power generator according to an embodiment of the present invention.

As shown in FIG. 8, the wind power plant control unit 110 measures an output value of the wind power plant before a predetermined time from an output control time of the wind power plant (S101).

Subsequently, the wind power plant control unit 110 calculates a maximum output value of the wind power plant on the basis of the measured output value of the wind power plant (S102).

In this case, the maximum output value of the wind power plant is an output value that all wind power generators should not exceed.

A method in which the wind power plant control unit 110 calculates the maximum output value has been described with reference to FIG. 2. That is, the wind power plant control unit 110 measures an output of a point of common coupling 111 of the wind power plant before a predetermined time (e.g., 1 minute) from the output control time of the wind power plant in order to calculate the maximum output value. Subsequently, the wind power plant control unit 110 calculates the maximum output value of the wind power plant by adding an output value corresponding to an output evaporation rate per minute that is specified in the power network interconnection standard to the measured output value of the wind power plant.

Subsequently, when the maximum output value of the wind power plant is calculated as described above, the wind power plant control unit 110 distributes individual maximum output values of the wind power plant to individual wind power generators 130 in the wind power plant (S103).

That is, the wind power plant control unit 110 distributes the individual maximum output values to the individual wind power generators 130 in proportion to maximum available outputs of the individual wind power generators 130.

In this case, when the individual maximum output values are distributed, the wind power plant control unit 110 may use a method of distributing the maximum output values in proportion to the maximum available outputs of the individual wind power generators 130 or a method of distributing the maximum output values in proportion to outputs of the individual wind power generators 130 at the control time of the wind power plant.

When the individual maximum output values are distributed to the individual wind power generators 130 as described above, the wind power generator control unit 120 controls the outputs of the individual wind power generators 130 according to the individual maximum output values (S104).

A method in which the wind power generator control unit 120 controls the outputs of the individual wind power generators 130 according to the individual maximum output values has been described with reference to FIG. 3. That is, the wind power generator control unit 120 sets original reference output values P_{ref}^{WGi} of the individual wind power generators 130 to new reference output values P_{newrej}^{WGi} limiting the original reference output values P_{ref}^{WGi} to the individual maximum output values Pᵤₚₚₑᵣₗᵢₘᵢₜ^{WGi} that are distributed by the wind power plant control unit 110.

In this case, when the original reference output values P_{ref}^{WGi} of the individual wind power generators 130 are greater than the individual maximum output values Pᵤₚₚₑᵣₗᵢₘᵢₜ^{WGi}the new reference output values P_{newrej}^{WGi} are set equal to the individual maximum output values Pᵤₚₚₑᵣₗᵢₘᵢₜ^{WGi}. Otherwise, the new reference output values P_{newrej}^{WGi} are set equal to the original reference output values P_{ref}^{WGi}.

Subsequently, the wind power generator control unit 120 calculates output errors by performing mathematical operations on the new reference output values P_{newrej}^{WGi} and output values Pₘₑₐₛ^{WGi} that are measured at terminals of the wind power generators and then calculates reference current values I_{d-rej}^{WGi} of the individual wind power generators 130 by performing mathematical operations on the output errors through a proportional integral controller PI.

The wind power generator control unit 120 calculates current errors by performing mathematical operations on the reference current values I_{d-rej}^{WGi} and current values I_{d}^{WGi} that are measured at the individual wind power generators 130 and then calculates reference voltage values V_{d-rej}^{WGi} of the individual wind power generators by performing mathematical operations on the current errors through the proportional integral controller PI.

Finally, the wind power generator control unit 120 controls the outputs by machine-side converters (MSCs) of the individual wind power generators 130 providing power corresponding to the reference voltage values V_{d-rej}^{WGi} of the individual wind power generators 130 calculated through the proportional integral controller PI to the system.

The wind power generator control unit 120 may prevent the total output of the wind power plant from exceeding the maximum output value Pᵤₚₚₑᵣₗᵢₘᵢₜ^{WPP} by controlling the outputs of the individual wind power generators 130 such that the outputs do not exceed the distributed maximum output values.

While the present invention has been described with reference to an embodiment shown in the accompanying drawings, it should be understood by those skilled in the art that this embodiment is merely illustrative of the invention and that various modifications and equivalents may be made without departing from the spirit and scope of the invention. Accordingly, the technical scope of the present invention should be determined only by the appended claims.

1. A system for controlling an output evaporation rate of a wind power plant, the system comprising:
a wind power plant control unit configured to measure an output value of the wind power plant before a predetermined time from an output control time of the wind power plant, calculate a maximum output value of the wind power plant based on the measured output value of the wind power plant, and distribute individual maximum output values of the wind power plant to individual wind power generators in the wind power plant; and
a wind power generator control unit configured to control outputs of the individual wind power generators according to the individual maximum output values when the individual maximum output values are distributed to the individual wind power generators.

2. The system of claim 1, wherein the maximum output value of the wind power plant is an output value that a sum of the outputs of the wind power generators in the wind power plant should not exceed.

3. The system of claim 1, wherein the wind power plant control unit calculates the maximum output value of the wind power plant by adding an output value corresponding to an output evaporation rate per minute that is specified in a power network interconnection standard to the measured output value of the wind power plant.

4. The system of claim 1, wherein the wind power plant control unit distributes the individual maximum output values in proportion to maximum available outputs of the individual wind power generators or in proportion to outputs of the individual wind power generators at the output control time of the wind power plant.

5. The system of claim 1, wherein the wind power generator control unit finally prevents an output of the wind power plant from exceeding the maximum output value (Pᵤₚₚₑᵣₗᵢₘᵢₜ^{WPP}) by controlling the outputs of the individual wind power generators such that the outputs do not exceed the distributed individual maximum output values.

6. The system of claim 5, wherein the wind power generator control unit sets original reference output values (P_{ref}^{WGi}) of the individual wind power generators to new reference output values (P_{newrej}^{WGi}) by limiting the original reference output values (P_{ref}^{WGi}) to the individual maximum output values (Pᵤₚₚₑᵣₗᵢₘᵢₜ^{WGi}) that are distributed by the wind power plant control unit, calculates output errors by performing mathematical operations on the new reference output values (P_{newrej}^{WGi}) and output values (Pₘₑₐₛ^{WGi}) that are measured at terminals of the wind power generators, calculates reference current values (P_{d-rej}^{WGi}) of the individual wind power generators by performing mathematical operations on the output errors through a proportional integral controller, calculates current errors by performing mathematical operations on the reference current values (I_{d-rej}^{WGi}) and current values (I_{d}^{WGi}) that are measured at the individual wind power generators, calculates reference voltage values (V_{d-rej}^{WGi}) of the individual wind power generators by performing mathematical operations on the current errors through the proportional integral controller, and controls the outputs by machine-side converters (MSCs) of the individual wind power generators providing power corresponding to the reference voltage values (V_{d-rej}^{WGi}) of the individual wind power generators calculated through the proportional integral controller to a system.

7. The system of claim 6, wherein when the original reference output values (P_{ref}^{WGi}) of the individual wind power generators are greater than the individual maximum output values (Pᵤₚₚₑᵣₗᵢₘᵢₜ^{WGi}), the new reference output values (P_{newrej}^{WGi}) are set equal to the individual maximum output values (Pᵤₚₚₑᵣₗᵢₘᵢₜ^{WGi}), and otherwise, the new reference output values (P_{newrej}^{WGi}) are set equal to the original reference output values (P_{ref}^{WGi}).

8. A method of controlling an output evaporation rate of a wind power plant, the method comprising:
measuring, by a wind power plant control unit, an output value of the wind power plant before a predetermined time from an output control time of the wind power plant;
calculating, by the wind power plant control unit, a maximum output value of the wind power plant based on the measured output value of the wind power plant;
distributing, by the wind power plant control unit, individual maximum output values of the wind power plant to individual wind power generators in the wind power plant; and
controlling, by a wind power generator control unit, outputs of the individual wind power generators according to the individual maximum output values when the individual maximum output values are distributed to the individual wind power generators.

9. The method of claim 8, wherein when the maximum output value of the wind power plant is calculated, the wind power plant control unit calculates the maximum output value of the wind power plant by adding an output value corresponding to an output evaporation rate per minute that is specified in a power network interconnection standard to the measured output value of the wind power plant.

10. The method of claim 8, wherein when the individual maximum output values of the wind power plant are distributed to the individual wind power generators in the wind power plant, the wind power plant control unit distributes the individual maximum output values in proportion to maximum available outputs of the individual wind power generators or in proportion to outputs of the individual wind power generators at the output control time of the wind power plant.

11. The method of claim 8, wherein when the outputs of the individual wind power generators are controlled, the wind power generator control unit sets original reference output values (P_{ref}^{WGi}) of the individual wind power generators to new reference output values (P_{newrej}^{WGi}) by limiting the original reference output values (P_{ref}^{WGi}) to the individual maximum output values (Pᵤₚₚₑᵣₗᵢₘᵢₜ^{WGi}) that are distributed by the wind power plant control unit, calculates output errors by performing mathematical operations on the new reference output values (P_{newrej}^{WGi}) and output values (Pₘₑₐₛ^{WGi}) that are measured at terminals of the wind power generators, calculates reference current values (I_{d-rej}^{WGi}) of the individual wind power generators by performing mathematical operations on the output errors through a proportional integral controller, calculates current errors by performing mathematical operations on the reference current values (I_{d-rej}^{WGi}) and current values (I_{d}^{WGi}) that are measured at the individual wind power generators, calculates reference voltage values (V_{d-rej}^{WGi}) of the individual wind power generators by performing mathematical operations on the current errors through the proportional integral controller, and controls the outputs by machine-side converters (MSCs) of the individual wind power generators providing power corresponding to the reference voltage values (V_{d-rej}^{WGi}) of the individual wind power generators calculated through the proportional integral controller to a system.

12. The method of claim 11, wherein when the original reference output values (P_{ref}^{WGi}) of the individual wind power generators are greater than the individual maximum output values (Pᵤₚₚₑᵣₗᵢₘᵢₜ^{WGi}), the new reference output values (P_{newrej}^{WGi}) are set equal to the individual maximum output values (Pᵤₚₚₑᵣₗᵢₘᵢₜ^{WGi}), and otherwise, the new reference output values (P_{newrej}^{WGi}) are set equal to the original reference output values (P_{ref}^{WGi}).
